(19) United States
(12) Patent Application Publication
(10) Pub. No.: US 2026/0310964 A1
(43) Pub. Date: Oct. 8, 2026

(54) HEAD-WISE TOKEN PRUNING METHOD AND ELECTRONIC DEVICE

(71) Applicant: Industrial Technology Research Institute, Hsinchu (TW)

(72) Inventors: Yao-Hua Chen, Taoyuan City (TW); Yu-Sung Lee, Kaohsiung City (TW); Chih-Tsun Huang, Hsinchu City (TW)

(73) Assignee: Industrial Technology Research Institute, Hsinchu (TW)

(21) Appl. No.: 19/578,909

(22) Filed: Mar. 26, 2026

Related U.S. Application Data
(60) Provisional application No. 63/785,582, filed on Apr. 8, 2025.

(30) Foreign Application Priority Data
Aug. 28, 2025 (TW) 114132795

(51) Int. Cl. G06N 3/082; G06N 3/045

(52) U.S. Cl. CPC G06N 3/082; G06N 3/045

(57) ABSTRACT

The disclosure provides a token pruning method and an electronic device. The method includes: computing a plurality of query matrices and a plurality of key matrices corresponding to a plurality of heads; computing an attention matrix according to the corresponding query matrix and key matrix for each of the heads, wherein the attention matrix corresponds to a plurality of tokens and includes a plurality of attention values; computing an importance corresponding to each of the tokens according to the corresponding attention value, and determining at least one pruned token according to the importance for each of the heads, wherein the pruned token of a first head is different from the pruned token of a second head; and omitting the pruned tokens corresponding to each of the heads in a subsequent computation.

### CROSS-REFERENCE TO RELATED APPLICATION

This application claims the priority benefits of U.S. provisional application Ser. No. 63/785,582, filed on Apr. 8, 2025 and Taiwan application serial no. 114132795, filed on Aug. 28, 2025. The entirety of each of the above-mentioned patent applications is hereby incorporated by reference herein and made a part of this specification.

### TECHNICAL FIELD

The disclosure relates to a head-wise token pruning method and an electronic device using the method.

### BACKGROUND

With the continuous evolution of artificial intelligence techniques, the field of natural language processing (NLP) has widely adopted deep neural network models based on the transformer architecture to solve various language tasks, such as machine translation, semantic analysis, dialogue generation, and question-answering systems. Via multi-layer self-attention mechanisms and feedforward neural networks, transformer models may effectively capture long-range dependencies between tokens in the input sequence and improve semantic representation capabilities. However, with the increasing demand for applications, the number of parameters and computational complexity of these models also increased significantly, resulting in huge computing resources and time costs in actual deployment, especially in edge devices or low-latency applications.

To address these issues, the industry has proposed various model compression techniques, one of which is token pruning. This technique reduces the computational load of subsequent layers by removing tokens that have less impact on the results. This method effectively reduces the computational burden while maintaining prediction accuracy. However, currently common token pruning methods often adopt a fixed pruning ratio and are unable to dynamically adjust the pruning strategy according to different contexts, resulting in limited effectiveness when processing diverse inputs.

### SUMMARY

In order to perform token pruning dynamically, the disclosure provides a token pruning method and an electronic device.

A token pruning method includes the following steps. A plurality of query matrices and a plurality of key matrices corresponding to a plurality of heads are computed. An attention matrix is computed according to the corresponding query matrix and key matrix for each of the heads, wherein the attention matrix corresponds to a plurality of tokens and includes a plurality of attention values. An importance corresponding to each of the tokens is computed according to the attention values, and at least one pruned token is determined according to the importances for each of the heads, wherein the pruned token of a first head is different from the pruned token of a second head. The pruned tokens corresponding to each of the heads are omitted in a subsequent computation.

From another perspective, the disclosure provides an electronic device including a memory and a processor. The memory stores a plurality of tokens. The processor is electrically connected to the memory and used to read the tokens and execute the token pruning method.

Several exemplary embodiments accompanied with figures are described in detail below to further describe the disclosure in details.

### BRIEF DESCRIPTION OF THE DRAWINGS

FIG. 1 is a schematic diagram illustrating an electronic device according to an embodiment.

FIG. 2 is a diagram illustrating an architecture of a neural network according to an embodiment.

FIG. 3 is a schematic diagram illustrating attention matrices of a plurality of heads according to an embodiment.

FIG. 4 is a schematic diagram illustrating determining an importance threshold value according to a variance according to an embodiment.

FIG. 5 is a schematic diagram illustrating multiplication of an attention matrix and a value matrix using a mask according to an embodiment.

FIG. 6 is a schematic diagram illustrating adding a matrix O to a matrix T using a mask according to an embodiment.

FIG. 7 is a schematic diagram illustrating sparse-dense-sparse mapping according to an embodiment.

FIG. 8 is a diagram illustrating the internal hardware configuration of a processor 110 according to an embodiment.

FIG. 9 is a flowchart illustrating a token pruning method according to an embodiment.

### DETAILED DESCRIPTION OF DISCLOSED EMBODIMENTS

Some embodiments of the disclosure are described in detail below with reference to the accompanying drawings. Reference numerals used in the following description identify identical or similar elements when the same reference numerals appear in different figures. These embodiments constitute a portion of the disclosure and do not disclose all possible implementations of the disclosure. Rather, these embodiments are illustrative of the systems and methods in the claims of the disclosure.

The terms “first”, “second”, etc., used herein do not particularly refer to an order or a sequence, but are used to distinguish elements or operations described with the same technical terms.

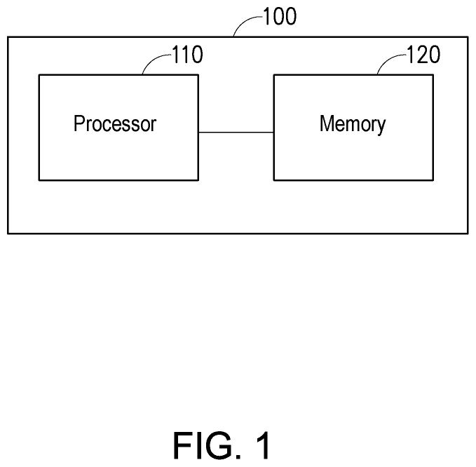

FIG. 1 is a schematic diagram illustrating an electronic device according to an embodiment. Referring to FIG. 1, an electronic device 100 may be a smartphone, a tablet computer, a personal computer, a laptop computer, a server, a distributed computer, a cloud server, an industrial computer, a graphics card, or various electronic device having computing capabilities, and the disclosure is not limited thereto. The electronic device 100 includes a processor 110 and a memory 120, and the processor 110 is electrically connected to the memory 120. The processor 110 may be a central processing unit (CPU), a deep-learning processing unit (DPU), a neural network processing unit (NPU), a tensor processing unit (TPU), an application-specific integrated circuit (ASIC), a programmable logic device (PLD), etc. The memory 120 may be random-access memory (RAM), flash memory, a floppy disk, a hard disk, an optical disk, a USB drive, a magnetic tape, or a database accessible via the internet, storing various data needed to execute one neural network, including weights, input tokens, etc. The processor 110 reads this data from the memory 120. Specifically, the processor 110 executes one token pruning method to omit the computation of some tokens in the neural network.

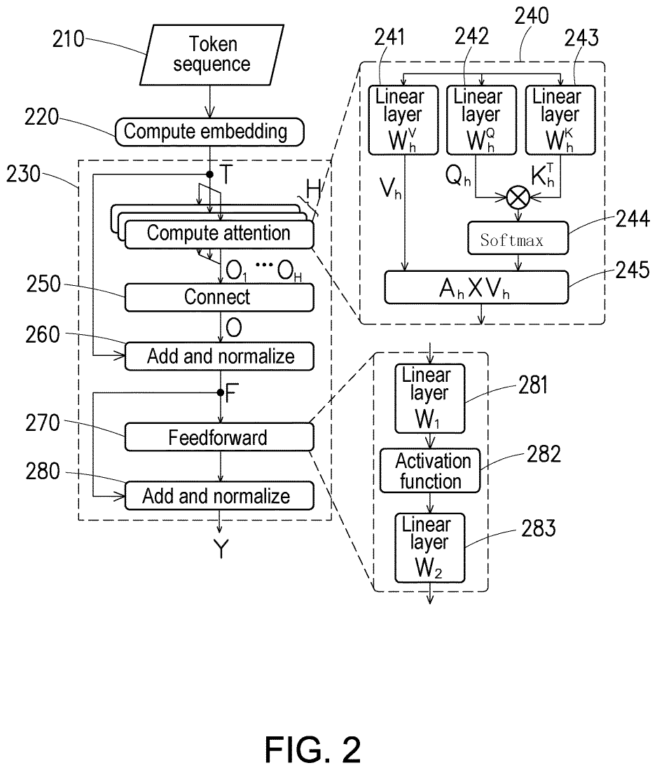

FIG. 2 is a diagram illustrating an architecture of a neural network according to an embodiment. Referring to FIG. 2, one token sequence 210 is first received. This token sequence 210 includes N tokens, wherein N is a positive integer. In the present embodiment, each of the tokens represents one word. However, in other embodiments, each of the tokens may also represent one or a plurality of letters, one or a plurality of pixels, a sound signal, or other types of data, and the disclosure is not limited thereto.

Next, in step 220, the embedding of each of the tokens is computed. For example, one linear layer or convolutional layer may be used. Each embedding is one vector with a length of D, wherein D is a positive integer. Therefore, the token sequence 210 may be represented as one matrix T of size N×D. A neural network includes a plurality of layers, and the computation of the first layer 230 is described here.

The first layer 230 has H heads, wherein His a positive integer. Taking a head 240 as an example, the matrix T first passes through three linear layers 241 to 243. These three linear layers 241 to 243 adopt weight matrices of

$${W}_{h}^{V} , {W}_{h}^{Q} , and {W}_{h}^{K} ,$$

respectively, wherein h represents the h-th head. The size of these weight matrices is

$$N \times \frac{D}{H} ,$$

but the disclosure is not limited thereto. In other embodiments, the weight matrices may also have more or fewer columns. The linear layers 241 to 243 are used to compute a value matrix Vₕ, a query matrix Qₕ, and a key matrix Kₙ, respectively.

One attention matrix may be computed according to the query matrix Qₕ and the key matrix Kₕ. For example, after the query matrix Qₕ and the transpose of the key matrix Kₕ are multiplied, the result is put in a normalized exponential function 244 (such as softmax) to obtain an attention matrix Aₕ. This computation may be expressed as the following Mathematical formula 1.

$${A}_{h} = softmax ( \frac{{Q}_{h} {K}_{h}^{T}}{\sqrt{\frac{D}{H}}} ) \qquad [ Mathematical formula 1 ]$$

The size of the attention matrix Aₕ is N×N, wherein each column and each row correspond to one token, and each of the elements in the matrix is also called an attention value (or attention probability). For each of the heads, the corresponding value matrix Vₕ, query matrix Qₕ, and key matrix Kₕ may be computed, and the corresponding attention matrix Aₕ may also be computed. Next, for each of the heads, the importance of each of the tokens is computed according to the attention value in the attention matrix Aₕ, and which tokens are pruned (also called pruned tokens) is determined according to the importances.

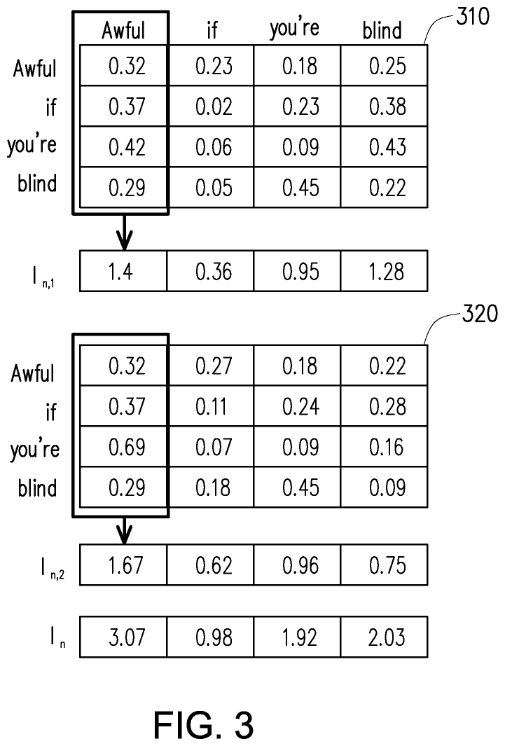

FIG. 3 is a schematic diagram illustrating the attention matrices of a plurality of heads according to an embodiment. An attention matrix 310 of a first head and an attention matrix 320 of a second head are illustrated here. In this example, there are four tokens in total, respectively “Awful”, “if”, “you're”, and “blind”. The tokens processed by different heads are the same. The normalized exponential function 244 is applied to the elements of the same row in the attention matrix, so the attention values of the same row in the attention matrices 310 and 320 add up to 1. In some embodiments, for each of the tokens, the corresponding attention values (same column) may be accumulated to obtain an importance I_{n,h}, and this computation may be expressed as the following Mathematical formula 2.

$${I}_{n , h} = {\sum }_{i = 1}^{N} {A}_{h} ( i , n ) \qquad [ Mathematical formula 2 ]$$

In particular, Aₕ(i, n) represents the attention value of the i-th row and the n-th column in the attention matrix corresponding to the h-th head. The importance I_{n,h} corresponds to the h-th head and the n-th token. For example, summing up the attention values of the first column in the attention matrix 310 may result an importance I_{1,1} of “1.4”. Similarly, summing up the attention values of the first column in the attention matrix 320 may result an importance I_{1,2} of “1.67”. It is worth noting that since different heads pay attention to different tokens, different importances are computed for the same token in different heads. For example, the second most important token in the first head is the fourth token (importance is 1.28), but the second most important token in the second head is the third token (importance is 0.96).

In addition, the layer importance Iₙ may be obtained by summing up the importances corresponding to the same token in all of the heads. This computation is shown in the following Mathematical formula 3.

$${I}_{n , h} = {\sum }_{i = 1}^{N} {\sum }_{h = 1}^{H} {A}_{h} ( i , n ) \qquad [ Mathematical formula 3 ]$$

In particular, Iₙ represents the layer importance of the n-th token. There are various ways to determine pruned tokens. In the present embodiment, whether the importance corresponding to each of the tokens in each of the heads is less than one critical importance value may be determined. In the case that the importance corresponding to each of the tokens in each of the heads is less than one critical importance value, the token is determined to be a pruned token. In other embodiments, the K tokens with the most importance may also be retained in each of the heads, and the remaining tokens are set as pruned tokens, wherein K is a positive integer. Therefore, the pruned tokens in the first head may be different from the pruned tokens in the second head. In some cases, the number of pruned tokens in the first head is different from the number of pruned tokens in the second head. Conventional techniques use the layer importance Iₙ to determine pruned tokens (e.g., the second token), so the pruned tokens in different heads are the same. However, in the disclosure, different tokens may be pruned in different heads. In some experiments, conventional methods reduce accuracy by 1.1% after pruning, but the method of the present embodiment reduces accuracy by 0.5% after pruning the same number of tokens, thus achieving better performance.

Various methods are proposed for determining the above importance threshold value. In an embodiment, for each of the heads, the dispersion degree of the importances of all of the tokens may be computed and the dispersion degree may be multiplied by a constant to compute the importance threshold value corresponding to the head. Since the dispersion degree of different heads may be different, the importance threshold value of the first head may be different from the importance threshold value of the second head. The dispersion degree may be variance or determined according to entropy.

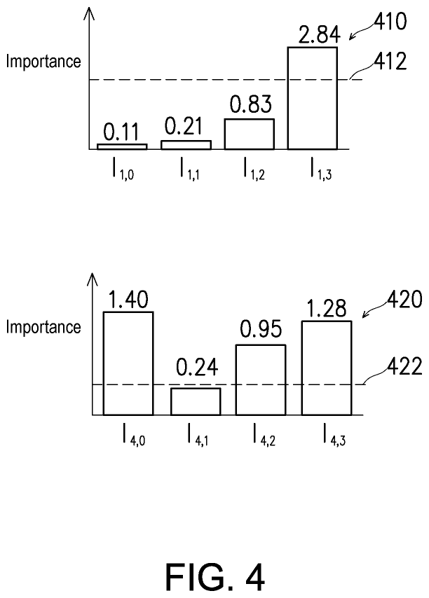

FIG. 4 is a schematic diagram illustrating determining an importance threshold value according to a variance according to an embodiment. Referring to FIG. 4, a graph 410 corresponds to the first head, and a graph 420 corresponds to the fourth head. The horizontal axis of the graphs 410 and 420 indicates the importance, and the vertical axis indicates the value of the importance. FIG. 4 is an example, wherein the importances are different from the importances computed in FIG. 3. The variance of the four importances in the graph 410 is 1.61, and the variance of the four importances in the graph 420 is 0.27. A greater variance indicates that the importances are concentrated in a small number of tokens, making it easier to determine which tokens are more important. Therefore, a greater importance threshold value may be set to prune a plurality of tokens. Conversely, a smaller variance indicates that the importances of the tokens are similar to each other, making it difficult to distinguish which tokens are more important. Therefore, a smaller importance threshold value may be set to retain more tokens. In this example, the constant is “0.97,” so the importance threshold value 412 of the first head is “1.56,” and the importance threshold value 422 of the fourth head is “0.26.” The pruned tokens of the first head are the first, second, and third tokens, and the pruned token of the fourth head is the second token.

In some embodiments, the importance threshold value may be determined according to entropy. For example, for each of the heads, the importances of all of the tokens may be normalized by an exponential function so that the sum is equal to 1 (representing probability), and then the entropy of the importances is computed. The entropy computed according to the importances of the graph 410 is smaller, and the entropy computed according to the importances of the graph 420 is greater. Therefore, importance threshold values and entropy may be set to be negatively correlated. For example, the inverse of the entropy may be computed and multiplied by a constant to serve as the importance threshold value, or a constant may be subtracted from the entropy to serve as the importance threshold value.

According to the above approach, different importance threshold values may be set in different heads. In some embodiments, the same importance threshold value may also be set in different heads. For example, referring to FIG. 3, after the layer importances Iₙ of all of the tokens are computed, the dispersion degree (e.g., the variance) of the layer importances may be computed, and then the dispersion degree may be multiplied by a constant to compute the importance threshold value. In this example, although the same importance threshold value is used in different heads, different pruned tokens are still determined due to the different importances in different heads.

The above constant may be determined by any suitable method, such as via a genetic algorithm, particle swarm optimization, or manually, but the disclosure is not limited thereto. For example, when a genetic algorithm is adopted, the following Mathematical formula 4 may be used as a fitness function (fitness score).

$$f ( x ) = 2 \times ( 1 - L ) + \overline{α} \qquad [ Mathematical formula 4 ]$$

In particular, x represents a candidate constant. In a genetic algorithm, each iteration has a plurality of candidate constants. L represents the reduced accuracy of the model using the candidate constant. α̅ represents the average value of all of the candidate constants. The genetic algorithm is well understood by those having ordinary skill in the art and is not discussed in detail here.

Referring to FIG. 2, after the pruned tokens are determined, the pruned tokens corresponding to each of the heads are omitted in a subsequent computation. The subsequent computation may include multiplication of the attention matrix Aₕ and the value matrix Vₕ, computation of the feedforward neural network, and/or computation of the next layer. In some embodiments, a mask is generated according to the pruned tokens and the mask is applied to the subsequent computation. For example, the mask may be used when computing the multiplication of the attention matrix Vₕ and the value matrix Vₕ in step 245.

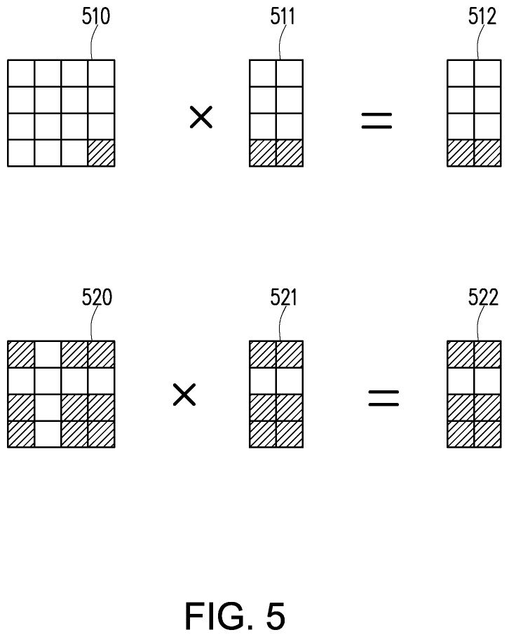

FIG. 5 is a schematic diagram illustrating the multiplication of an attention matrix and a value matrix using a mask according to an embodiment. Referring to FIG. 4 and FIG. 5, continuing with the example of FIG. 4, an attention matrix 510 belongs to the first head, wherein the first, second, and third tokens are pruned tokens. The mask may be represented using two-dimensional data or may also be represented using other forms (e.g., represented as one sequence used to indicate the first, second, and third tokens). When the mask is applied to the attention matrix 510, since the first row to the third row and the first column to the third column all correspond to pruned tokens, the elements of the fourth row and fourth column are retained. Furthermore, the first row to the third row in a value matrix 511 also correspond to pruned tokens and are therefore also omitted. Multiplying the attention matrix 510 by the value matrix 511 using the corresponding mask yields an attention output 512. In the attention output 512, the first row to the third row also correspond to pruned tokens and are therefore all masked elements (e.g., null values or the value “0”). Similarly, an attention matrix 520 belongs to the fourth head. Continuing with the example of FIG. 4, the second token is the pruned token. Therefore, the mask of the fourth head is used to indicate the second token. The elements of the second row and the second column in the attention matrix 520 are masked, and the second row in the value matrix 512 is masked. Multiplying the attention matrix 520 by the value matrix 521 using the mask yields an attention output 522, wherein the second row includes a plurality of masked elements.

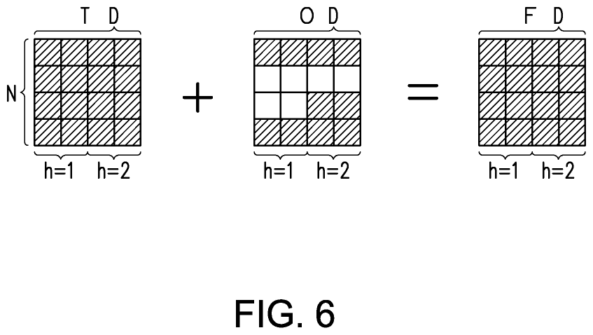

Referring to FIG. 2, next in step 250, the attention outputs of all of the heads are concatenated. Here, Oₕ represents the attention output corresponding to the h-th head, wherein h=1 to H. After concatenation, the attention outputs may be represented as a matrix O=[O₁O₁ . . . O_{H}] of size N×D. Next, in step 260, addition and normalization are performed, wherein the addition operation is also called a residual layer used to add the matrix O to the matrix T to obtain a matrix F. As shown in FIG. 6, FIG. 6 is a schematic diagram illustrating adding of the matrix O to the matrix T using a mask according to an embodiment. In other words, during the addition, masked elements in the matrix O are not added to the matrix T, or masked elements in the matrix O have the value “0” and therefore do not affect the corresponding values in the matrix T. In this example, the second token and the third token in the first head (h=1) are pruned tokens, and the second token in the second head (h=2) is a pruned token. Furthermore, normalization involves, for example, subtracting the average value from the values in the matrix and dividing by the standard deviation. In some embodiments, step 260 may be removed or replaced with other computations. For generalization, the matrix F includes a plurality of attention outputs.

Next, feed forwarding is performed in step 270 of FIG. 2. From another perspective, the matrix F is input into one feedforward neural network (FFN), and the network includes a linear layer 281, an activation function 282, and a linear layer 283. The linear layer 281 multiplies the input by a matrix W₁, and the linear layer 283 multiplies the input by a matrix W₂. In some embodiments, the activation function 282 is a Gaussian Error Linear Unit (GeLU). Since the operations of the linear layer 281 and the linear layer 283 are the same, one is described here. In particular, due to the different pruned tokens in different heads, the matrix F is sparse. Here, the matrix Fis split into a plurality of dense matrices, and the dense matrices are then merged into a sparse matrix after matrix multiplication. This practice is called sparse-dense-sparse mapping.

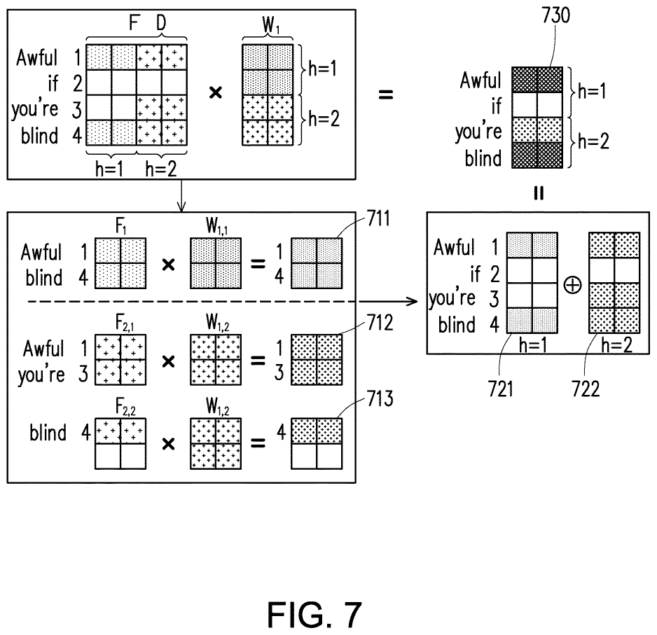

FIG. 7 is a schematic diagram illustrating sparse-dense-sparse mapping according to an embodiment. Referring to FIG. 7, the four rows of the matrix F correspond to four tokens, respectively “Awful,” “if,” “you're,” and “blind,” and the numbers 1 to 4 represent the indices of the tokens. The matrix F includes the attention outputs of a plurality of heads. The second token and the third token in the attention output of the first head (h=1) are masked, and the second token in the second head (h=2) is masked. For each of the heads, the masked elements in the corresponding attention output are removed to obtain one or a plurality of dense matrices. For example, after the masked elements are removed, the first attention output is a dense matrix F₁. The two numbers “1” and “4” at the left represent the indices of the remaining tokens, respectively. Furthermore, after the masked elements are removed, the second attention output is a dense matrix F_{2,1} and a dense matrix F_{2,2}, respectively, retaining the first, third, and fourth tokens. In the present embodiment, the size of each of the dense matrices is 2, but in other embodiments, any value may be used. Since three tokens are retained in the second attention output, some elements in the resulting second matrix F_{2,2} are still masked.

In addition, the size of the matrix Wiis D×D_{FFN}, wherein D_{FFN} is a positive integer. The attention outputs of the first head (h=1) in the matrix F are located in the first column and the second column, and therefore correspond to the first row and the second row in the matrix W₁ in matrix multiplication. Similarly, the attention outputs of the second head (h=2) in the matrix F are located in the third column and the fourth column, and therefore correspond to the third row and the fourth row in the matrix W₁ in matrix multiplication. Therefore, here, the elements of the first row and the second row in the matrix W₁ are extracted to form a submatrix W_{1,1}, and the elements of the third row and the fourth row in the matrix W₁ are extracted to form a submatrix W_{1,2}.

Next, the dense matrix is multiplied by the corresponding submatrix to obtain a dense result matrix. For example, the dense matrix F₁ is multiplied by the submatrix W_{1,1} to obtain a dense result matrix 711. A dense matrix F_{2,1} is multiplied by the submatrix W_{1,2} to obtain a dense result matrix 712. A matrix F_{2,2} is multiplied by the submatrix W_{1,2} to obtain a matrix 713, wherein the elements in the second row are masked.

Next, for each of the heads, the dense result matrices are restored to sparse result matrices according to the content of the masks. For example, the dense result matrix 711 may be restored to a sparse result matrix 721, and the dense result matrix 712 and the matrix 713 may be restored to a sparse result matrix 722. From another perspective, the elements in the dense result matrix are filled into the sparse result matrix according to the indices of the unmasked tokens. For example, two rows in the dense result matrix 711 are filled into the first row and the fourth row in the sparse result matrix 721, respectively; two rows in the dense result matrix 712 are filled into the first row and the third row in the sparse result matrix 722; and the first row in the matrix 713 is filled into the fourth row in the sparse result matrix 722.

The sparse result matrix 721 belongs to the first head. The sparse result matrix 722 belongs to the second head. Next, the sparse result matrices corresponding to all of the heads are added element-wise to obtain the feedforward result. In this example, the sparse result matrix 721 is added element-wise to the sparse result matrix 722 to obtain a feedforward result matrix 730. The feedforward result matrix 730 is the same as the result of directly multiplying the matrix F by the matrix W₁. In the case that the matrix F is directly multiplied by the matrix W₁, the related computations are invalid since some elements are masked, wasting computing resources. On the contrary, most of the multiplications in the above method all process dense matrices. As a result, the utilization of hardware may be improved and the computing speed of the neural network may be accelerated.

Referring to FIG. 2, step 280 is then performed to perform addition and normalization, ultimately generating a matrix Y. The matrix Y may be passed to the next layer or used as the output of the neural network. The output of the neural network may be used for classification, regression, generation, and segmentation, etc., but the disclosure is not limited thereto.

In the above embodiment, the mask is computed and applied to the same layer. In other embodiments, the computed mask may be applied to the next layer (referred to as the second layer). For example, the pruned tokens computed in the first layer are omitted from each of the heads of the second layer. In some embodiments, a plurality of layers of masks may also be combined, for example, by voting to determine masked tokens. The above delays token pruning but may avoid deleting important tokens.

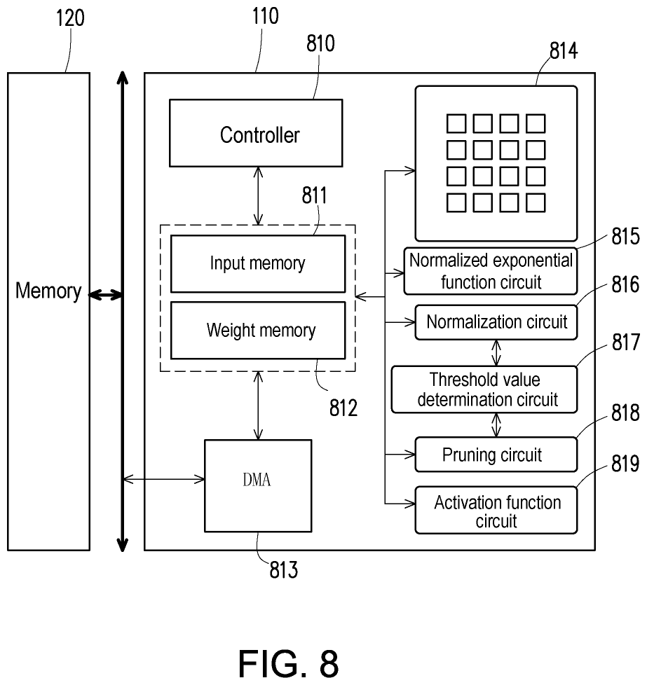

FIG. 8 is a diagram illustrating the internal hardware configuration of the processor 110 according to an embodiment. Referring to FIG. 8, the processor 110 includes a controller 810, an input memory 811, a weight memory 812, a direct memory access (DMA) circuit 813, a systolic array 814, a normalized exponent function circuit 815, a normalization circuit 816, a threshold value determination circuit 817, a pruning circuit 818, and an activation function circuit 819.

The memory 120 stores input data (including a plurality of tokens) and weights. The controller 810 controls the operational flow of the entire processor, including data movement, initiating operations, and triggering execution of various circuits, etc. The DMA circuit 813 reads input data from the memory 120 into the input memory 811 and reads weights into the weight memory 812. The matrix array 814 is used to perform matrix multiplication. The matrix array 814 includes a plurality of processing elements (PEs). In the present embodiment, due to the use of sparse-dense-sparse mapping, the utilization efficiency of the processing elements is higher. For example, the size of the dense matrix is 2×2, thus ensuring the use of the 2×2 PE array. In the case that matrix multiplication is performed on a sparse matrix, some PEs are idle. The normalized exponential function circuit 815 is used to execute a normalized exponential function. The normalization circuit 816 is used to perform normalization. The threshold value determination circuit 817 is used to compute an importance threshold value according to the dispersion degree of importance. For example, the threshold value determination circuit 817 may compute variance or entropy. The pruning circuit 818 is used to determine which tokens are to be pruned. The excitation function circuit 819 is used to execute the excitation function. However, FIG. 8 is an example, and the disclosure does not limit the internal hardware configuration of the processor 110.

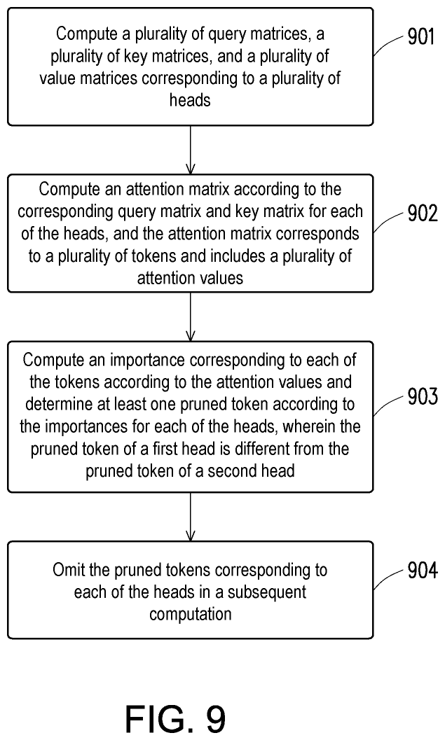

FIG. 9 is a flowchart illustrating a token pruning method according to an embodiment. Referring to FIG. 9, in step 901, a plurality of query matrices, a plurality of key matrices, and a plurality of value matrices corresponding to a plurality of heads are computed. In step 902, for each of the heads, an attention matrix is computed according to the corresponding query matrix and key matrix. The attention matrix corresponds to a plurality of tokens and includes a plurality of attention values. In step 903, for each of the heads, the importance corresponding to each of the tokens is computed according to the attention values, and at least one pruned token is determined according to the importance, wherein the pruned token of the first head is different from the pruned token of the second head. In step 904, the pruned tokens corresponding to each of the heads are omitted in the subsequent computation.

It will be apparent to those skilled in the art that various modifications and variations may be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A token pruning method, adapted to an electronic device, the token pruning method comprising:
computing a plurality of query matrices and a plurality of key matrices corresponding to a plurality of heads;
computing an attention matrix according to the corresponding query matrix and key matrix for each of the heads, wherein the attention matrix corresponds to a plurality of tokens and comprises a plurality of attention values;
computing an importance corresponding to each of the tokens according to the attention values and determining at least one pruned token in the tokens according to the importance for each of the heads, wherein the heads comprise a first head and a second head, and the at least one pruned token of the first head is different from the at least one pruned token of the second head; and
omitting the at least one pruned token corresponding to each of the heads in a subsequent computation.

2. The token pruning method of claim 1, wherein computing the importance corresponding to each of the tokens according to the attention values comprises:
accumulating the attention values corresponding to one of the tokens to obtain the importance.

3. The token pruning method of claim 2, wherein determining the at least one pruned token in the tokens according to the importance comprises:
determining whether the corresponding importance is less than an importance threshold value for one of the tokens, and determining that the one of the tokens belongs to the at least one pruned token in a case that the corresponding importance is less than the importance threshold value for the one of the tokens.

4. The token pruning method of claim 3, further comprising:
computing a dispersion degree of the importances of the tokens and multiplying the dispersion degree by a constant to compute the importance threshold value corresponding to the head for each of the heads, wherein the importance threshold value of the first head is different from the importance threshold value of the second head.

5. The token pruning method of claim 4, wherein the dispersion degree is a variance.

6. The token pruning method of claim 3, further comprising:
accumulating the importances corresponding to the heads for each of the tokens to obtain a layer importance; and
computing a dispersion degree of the layer importances of the tokens, and multiplying the dispersion degree by a constant to compute the importance threshold value, wherein the importance threshold value of the first head is the same as the importance threshold value of the second head.

7. The token pruning method of claim 1, wherein the step of omitting the at least one pruned token corresponding to each of the heads in the subsequent computation comprises:
generating a mask according to the corresponding at least one pruned token for each of the heads; and
multiplying the corresponding attention matrix by a corresponding value matrix using the corresponding mask to obtain an attention output for each of the heads, wherein the attention output comprises a plurality of masked elements corresponding to the at least one pruned token.

8. The token pruning method of claim 7, further comprising:
removing the masked elements in the corresponding attention output to obtain a dense matrix, multiplying the dense matrix by a submatrix of a weight matrix to obtain a dense result matrix, and restoring the dense result matrix to a sparse result matrix according to the corresponding mask for each of the heads.

9. The token pruning method of claim 8, further comprising:
adding the sparse result matrices corresponding to the heads element-wise to obtain a feedforward result matrix.

10. The token pruning method of claim 1, wherein the query matrices and the key matrices belong to a first layer in a neural network, and the step of omitting the at least one pruned token corresponding to each of the heads in the subsequent computation comprises:
omitting the corresponding at least one pruned token at the heads in a second layer of the neural network.

11. An electronic device, comprising:
a memory used to store a plurality of tokens; and
a processor electrically connected to the memory and used to read the tokens and execute a plurality of steps:
computing a plurality of query matrices and a plurality of key matrices corresponding to a plurality of heads;
computing an attention matrix according to the corresponding query matrix and key matrix for each of the heads, wherein the attention matrix corresponds to the tokens and comprises a plurality of attention values;
computing an importance corresponding to each of the tokens according to the attention values and determining at least one pruned token in the tokens according to the importance for each of the heads, wherein the heads comprise a first head and a second head, and the at least one pruned token of the first head is different from the at least one pruned token of the second head; and
omitting the at least one pruned token corresponding to each of the heads in a subsequent computation.

12. The electronic device of claim 11, wherein computing the importance corresponding to each of the tokens according to the attention values comprises:
accumulating the attention values corresponding to one of the tokens to obtain the importance.

13. The electronic device of claim 12, wherein determining the at least one pruned token in the tokens according to the importance comprises:
determining whether the corresponding importance is less than an importance threshold value for one of the tokens, and determining that the one of the tokens belongs to the at least one pruned token in a case that the corresponding importance is less than the importance threshold value for the one of the tokens.

14. The electronic device of claim 13, wherein the steps further comprise:
computing a dispersion degree of the importances of the tokens and multiplying the dispersion degree by a constant to compute the importance threshold value corresponding to the head for each of the heads, wherein the importance threshold value of the first head is different from the importance threshold value of the second head.

15. The electronic device of claim 14, wherein the dispersion degree is a variance.

16. The electronic device of claim 13, wherein the steps further comprise:
accumulating the importances corresponding to the heads to obtain a layer importance for each of the tokens; and
computing a dispersion degree of the layer importances of the tokens and multiplying the dispersion degree by a constant to compute the importance threshold value, wherein the importance threshold value of the first head is the same as the importance threshold value of the second head.

17. The electronic device of claim 11, wherein the step of omitting the at least one pruned token corresponding to each of the heads in the subsequent computation comprises:
generating a mask according to the corresponding at least one pruned token for each of the heads; and
multiplying the corresponding attention matrix by a corresponding value matrix using the corresponding mask to obtain an attention output for each of the heads, wherein the attention output comprises a plurality of masked elements corresponding to the at least one pruned token.

18. The electronic device of claim 17, wherein the steps further comprise:
removing the masked elements in the corresponding attention output to obtain a dense matrix, multiplying the dense matrix by a submatrix of a weight matrix to obtain a dense result matrix, and restoring the dense result matrix to a sparse result matrix according to the corresponding mask for each of the heads.

19. The electronic device of claim 18, wherein the steps further comprise:
adding the sparse result matrices corresponding to the heads element-wise to obtain a feedforward result matrix.

20. The electronic device of claim 11, wherein the query matrices and the key matrices belong to a first layer in a neural network, and the step of omitting the at least one pruned token corresponding to each of the heads in the subsequent computation comprises:
omitting the at least one pruned token corresponding to the heads in a second layer of the neural network.
